(19) United States
(12) Patent Application Publication
(10) Pub. No.: US 2026/0353452 A1
(43) Pub. Date: Nov. 5, 2026

(54) CROSS-LINK INTERFERENCE (CLI) MEASUREMENT SKIPPING

(71) Applicant: QUALCOMM Incorporated, San Diego, CA (US)

(72) Inventors: Yuwei REN, Beijing (CN); Yan ZHOU, San Diego, CA (US); Huilin XU, Beijing (CN); Qian ZHANG, Basking Ridge, NJ (US)

(21) Appl. No.: 19/486,829

(22) PCT Filed: Jun. 25, 2023
(86) PCT No.: PCT/CN2023/102041

§ 371 Date: Nov. 21, 2025

(51) Int. Cl. H04W 74/0816; H04B 7/06; H04B 17/309; H04L 5/14; H04W 56/00; H04W 72/11; H04W 72/231; H04W 76/20

(52) U.S. Cl. CPC H04W 74/0816; H04B 7/0626; H04B 17/346; H04L 5/1469; H04W 56/0015; H04W 72/11; H04W 72/231; H04W 76/20

(57) ABSTRACT

Certain aspects of the present disclosure provide a method for wireless communications at a user equipment (UE). The first UE may receive an indication that a second UE will not transmit in at least one symbol overlapping with an occasion configured for the first UE for measuring a cross-link interference (CLI). The first UE may skip the occasion for measuring the CLI, in response to the received indication.

### BACKGROUND

### Field of the Disclosure

Aspects of the present disclosure relate to wireless communications, and more particularly, to techniques for managing cross-link interference (CLI) measurement.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by a first user equipment (UE). The method includes receiving an indication that a second UE will not transmit in at least one symbol overlapping with an occasion configured for the first UE for measuring a cross-link interference (CLI); and skipping the occasion for measuring the CLI, in response to the received indication.

Other aspects provide: an apparatus operable, configured, or otherwise adapted to perform the aforementioned methods as well as those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example BS and an example user equipment (UE).

FIGS. 4A, 4B, 4C, and 4D depict various example aspects of data structures for a wireless communications network.

FIG. 5 depicts example physical uplink shared channels (PUSCHs) scheduled by a single downlink control information (DCI).

FIG. 6 depicts example multiple PUSCH occasions in each configured grant (CG) period.

FIG. 7 depicts example cross-link interference (CLI) between UEs associated with different cells.

FIG. 8 depicts example CLI between UEs associated with a same cell.

FIG. 9 depicts a call flow diagram illustrating example communication among a first UE and a network entity.

FIG. 10 depicts example overlapping of at least one CLI measurement occasion configured for a first UE with at least one cell-specific downlink (DL) symbol.

FIG. 11 depicts example CLI measurement occasions configured for a first UE.

FIG. 12 depicts example sub-band full duplex (SBFD) slot.

FIG. 13 depicts example resources for a first UE and a second UE.

FIG. 14 depicts a method for wireless communications at a first UE.

FIG. 15 depicts aspects of example communications device.

### DETAILED DESCRIPTION

Aspects of the present disclosure provide apparatuses, methods, processing systems, and computer-readable mediums for managing cross-link interference (CLI) measurement.

In some wireless networks, full duplex (FD) communications may be supported where devices can simultaneously transmit and receive. In FD communications between a network entity (such as a base station (BS), a cell, or component thereof) and a user equipment (UE), simultaneous transmission and reception may be accomplished with frequency division duplexing (FDD) using different frequency resources for uplink (UL) and downlink (DL). In some cases, time division duplexing (TDD) may be used with different time resources used for different users or different types of (UL/DL) transmissions. While FDD networks have separate UL and DL frequency bands and may support FD communications, TDD networks may utilize a same bandwidth, but allocate different time slots for UL and DL. In some cases, the TDD networks may experience some interference when the BSs interfere with each other as they transmit and receive in a same frequency band.

In a TDD network, cross-link interference (CLI) may occur between UEs in a same cell or adjacent cells. For example, UL transmissions by a first UE may interfere with DL transmissions to a second UE. If the first UE and the second UE may be in different cells that use different TDD UL-DL configurations, it may lead to conflicting symbol periods and UL-DL slot formats (with one UE transmitting on the UL while the other UE is receiving on the DL). In this context, the transmitting UE may be referred to as an aggressor UE, while the receiving UE may be referred to as a victim UE.

In some cases, a UE may be configured with a CLI measurement configuration, so that the UE may perform (assist in) interference management. For example, a UE configured for CLI measurement may measure certain (time/frequency) resources at times when another UE may be transmitting reference signals (RSs), such as sounding reference signals (SRSs). The CLI measurements may include measurements of the SRSs or reference signal received power (RSRP) measurement.

For various reasons, a UE may not transmit the RS used for the CLI at one or more semi-static DL symbols. For example, there may be no scheduling of the one or more RSs at the one or more semi-static DL symbols. In another example, the transmitting UE may not receive an indication of a format for a slot containing the one or more semi-static DL symbols and, thus, may be unable to transmit the one or more RSs at the one or more semi-static DL symbols.

Unfortunately, if CLI RS is not transmitted in a measurement occasion, CLI measurement accuracy may suffer and may result in unnecessary power consumption at the victim UE. Aspects of the present disclosure, however, allow a victim UE to skip CLI measurement occasions if it determines an aggressor UE will not transmit CLI RS. For example, the victim UE may skip the CLI measurement occasions that overlap with semi-static DL symbols (in which the aggressor UE will not transmit).

Particular aspects of the subject matter described in this disclosure can be implemented to realize one or more of the following potential advantages. In some examples, the described techniques can be used to improve CLI measurement accuracy and reduce a power consumption of the victim UE by skipping CLI measurement occasions when CLI RS transmission is not expected.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

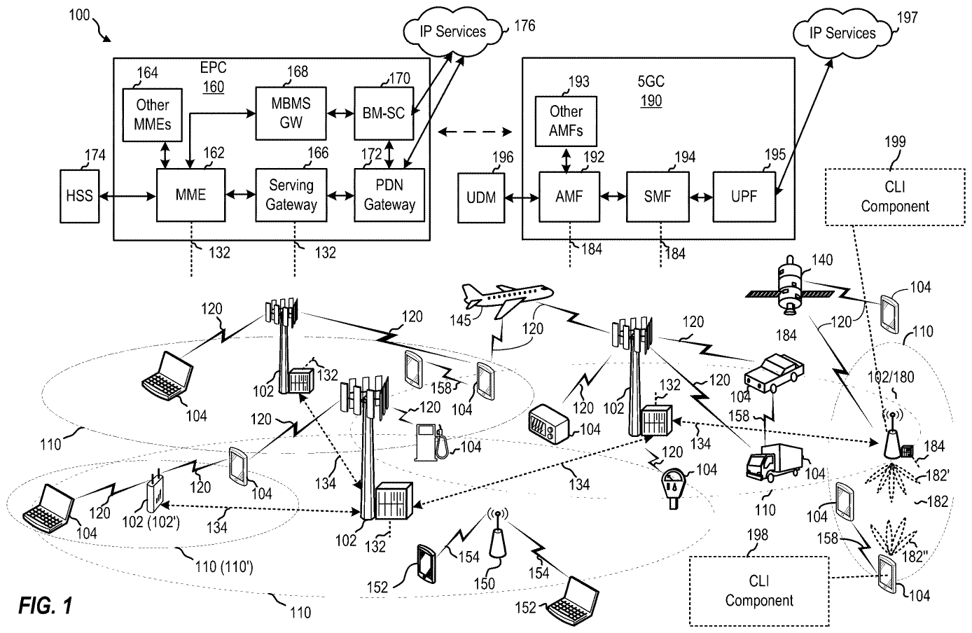

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio BS, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

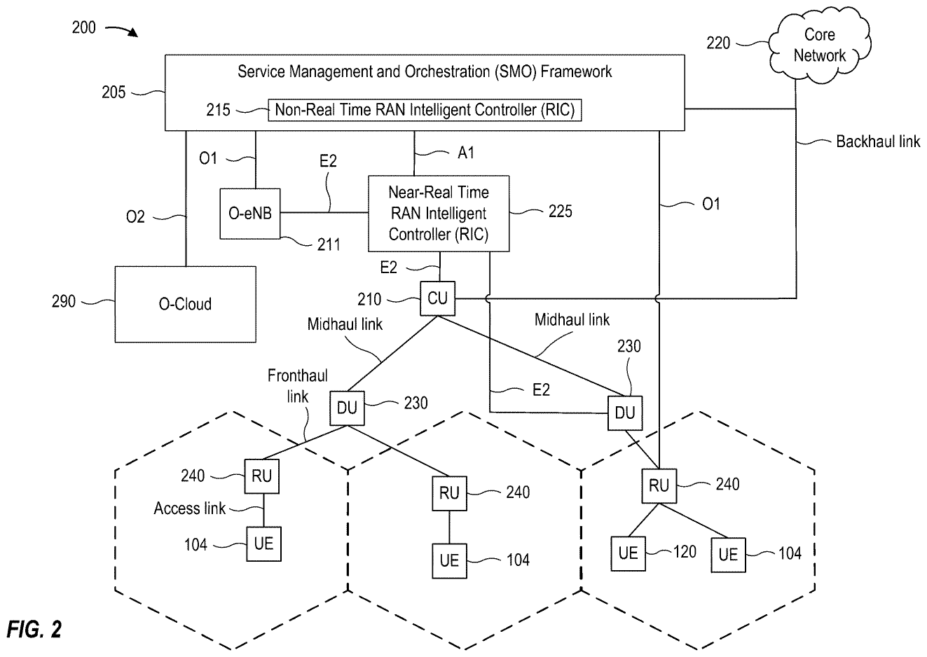

While BSs 102 are depicted in various aspects as unitary communications devices, BSs 102 may be implemented in various configurations. For example, one or more components of a BS 102 may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a BS 102 may be virtualized. More generally, a BS (e.g., BS 102) may include components that are located at a single physical location or components located at various physical locations. In examples in which a BS 102 includes components that are located at various physical locations, the various components may each perform functions such that, collectively, the various components achieve functionality that is similar to a BS 102 that is located at a single physical location. In some aspects, a BS 102 including components that are located at various physical locations may be referred to as a disaggregated radio access network (RAN) architecture, such as an Open RAN (O-RAN) or Virtualized RAN (VRAN) architecture. FIG. 2 depicts and describes an example disaggregated BS architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR 1) as including 600 MHz-6 GHz, which is often referred to (interchangeably) as “Sub-6 GHz”. Similarly, 3GPP currently defines Frequency Range 2 (FR2) as including 26-41 GHz, which is sometimes referred to (interchangeably) as a “millimeter wave” (“mmW” or “mmWave”). A BS configured to communicate using mm Wave/near mmWave radio frequency bands (e.g., a mm Wave BS such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain BSs (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

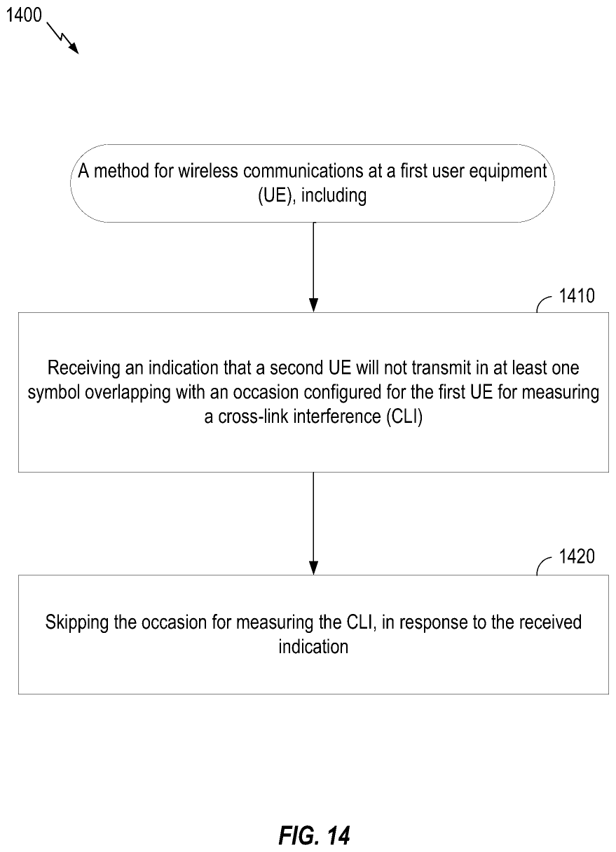

Wireless communication network 100 further includes cross-link interference (CLI) component 198, which may be configured to perform method 1400 of FIG. 14. Wireless communication network 100 further includes CLI component 199.

In various aspects, a network entity or network node can be implemented as an aggregated BS, as a disaggregated BS, a component of a BS, an integrated access and backhaul (IAB) node, a relay node, a sidelink node, to name a few examples.

FIG. 2 depicts an example disaggregated BS 200 architecture. The disaggregated BS 200 architecture may include one or more central units (CUs) 210 that can communicate directly with a core network 220 via a backhaul link, or indirectly with the core network 220 through one or more disaggregated BS units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more BS functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an Ol interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

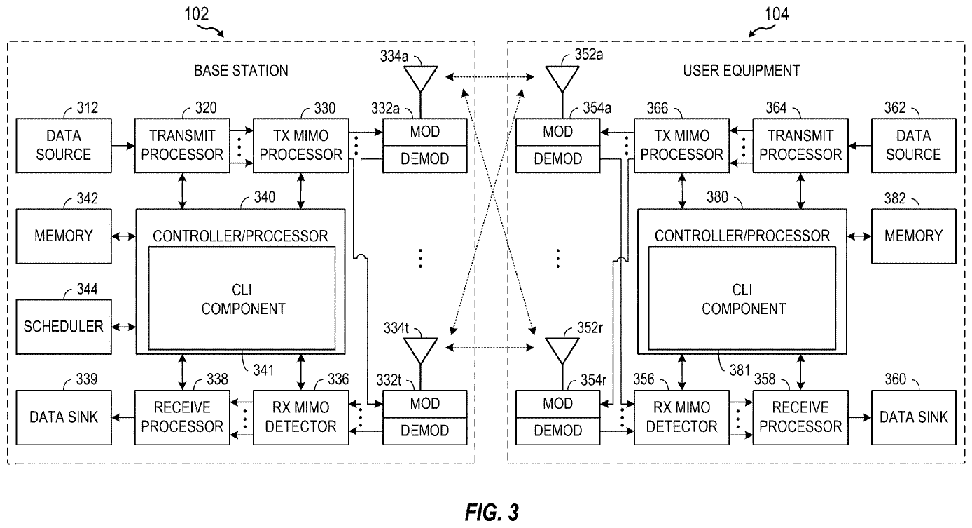

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

BS 102 includes controller/processor 340, which may be configured to implement various functions related to wireless communications. In the depicted example, controller/processor 340 includes CLI component 341, which may be representative of CLI component 199 of FIG. 1. Notably, while depicted as an aspect of controller/processor 340, CLI component 341 may be implemented additionally or alternatively in various other aspects of BS 102 in other implementations.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

UE 104 includes controller/processor 380, which may be configured to implement various functions related to wireless communications. In the depicted example, controller/processor 380 includes CLI component 381, which may be representative of CLI component 198 of FIG. 1. Notably, while depicted as an aspect of controller/processor 380, CLI component 381 may be implemented additionally or alternatively in various other aspects of UE 104 in other implementations.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

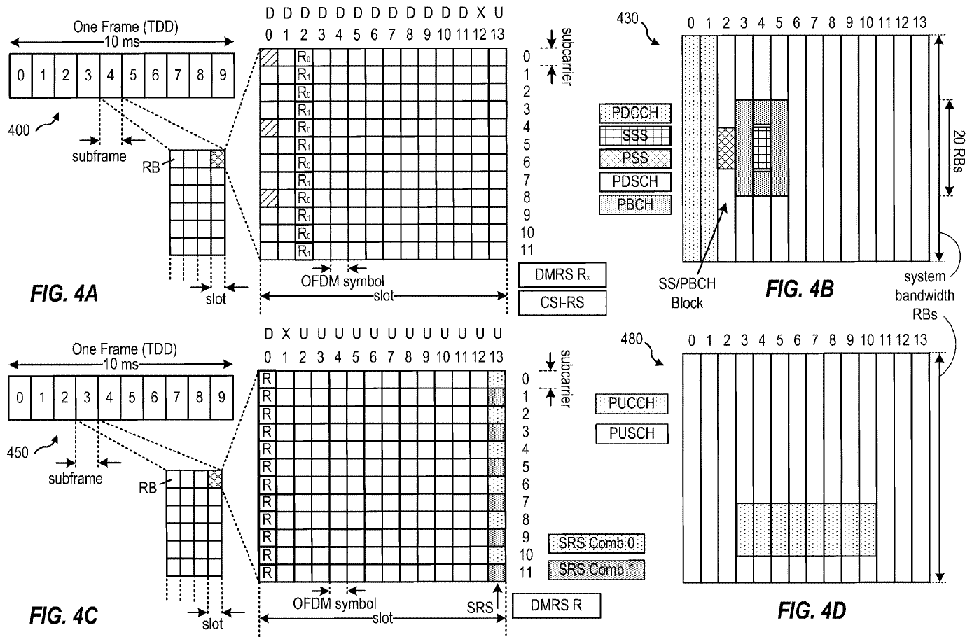

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the BS. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a BS for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5^{th} generation (5G) networks may utilize several frequency ranges, which in some cases are defined by a standard, such as 3rd generation partnership project (3GPP) standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mm Wave/near mm Wave radio frequency band (e.g., 3 GHz-300 GHz) may have higher path loss and a shorter range compared to lower frequency communications. As described above with respect to FIG. 1, a base station (BS) (e.g., 180) configured to communicate using mmWave/near mmWave radio frequency bands may utilize beamforming (e.g., 182) with a user equipment (UE) (e.g., 104) to improve path loss and range.

### Overview of Scheduling of Physical Uplink Shared Channel (PUSCH)

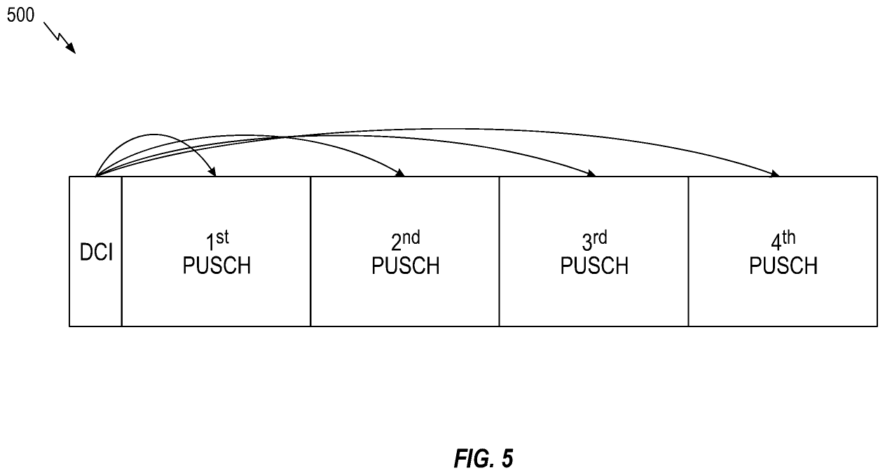

In some cases, a single downlink control information (DCI) may schedule multiple physical uplink shared channels (PUSCHs) for a user equipment (UE) (e.g., at least for a time division duplexed (TDD) frequency range (FR) 2-2 band). For example, as depicted in a diagram 500 of FIG. 5, a DCI schedules a first PUSCH, a second PUSCH, a third PUSCH, and a fourth PUSCH for the UE. The scheduling of the multiple PUSCHs using the single DCI may help reduce PDCCH monitoring efforts by the UE, which is significant for a small slot duration for high a subcarrier spacing (SCS) (e.g., 480 and 960 kilohertz (kHz)).

The DCI includes a time domain resource allocation (TDRA) field. The TDRA field indicates time domain resources for the multiple PUSCHs. In some cases, a number of scheduled PUSCHs may be implicitly indicated to the UE by a number of valid separate start and length indicator vectors (SLIVs). For example, the TDRA field in the DCI points to a row of a radio resource control (RRC) configured TDRA table that contains multiple SLIVs indicating a start symbol and a number of symbols in a slot allocated to the scheduled PUSCHs and a slot offset (K1) indicating the scheduling slot offset for the PUSCHs. In some cases, the number of scheduled PUSCHs by the DCI is equal to a number of indicated SLIVs and K1s.

In one example, each PUSCH has a separate SLIV, per the time domain resources. In another example, each PUSCH has a separate mapping type, per the time domain resources. In another example, each PUSCH has a separate offset between a slot in which the DCI is received and the PUSCH is scheduled, per the time domain resources. In another example, each PUSCH has a separate repetition number, per the time domain resources. In some cases, the DCI may indicate a repetition number per PUSCH (e.g., for each of the multiple PUSCHs). In some cases, the DCI may indicate the repetition number common to all of the multiple PUSCHs.

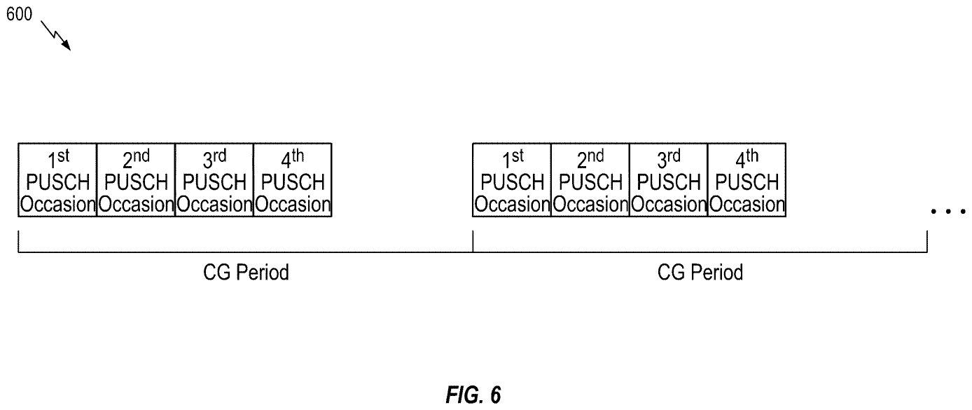

In some cases, multiple PUSCH occasions for the multiple PUSCHs are specified. For example, the multiple PUSCH occasions are specified in a configured grant (CG) period for the transmission of the periodic uplink (UL) traffic with a large data packet size (e.g., at least one extended reality (XR) video frame). For example, as depicted in a diagram 600 of FIG. 6, four PUSCH occasions including a first PUSCH occasion, a second PUSCH occasion, a third PUSCH occasion, and a fourth PUSCH occasion are specified in each CG period for the transmission of the periodic uplink UL traffic by the UE.

### Overview of Cross-Link Interference (CLI)

A wireless communications system may employ time division duplexed (TDD) communications, where a wireless channel is used for both uplink (UL) transmissions and downlink (DL) transmissions.

In a TDD system with macro cells which provide a wide coverage area, the macro cells may use a same TDD UL/DL configuration. For example, the multiple macro cells may use a same slot format which provides, on average, a largest throughput for a large number of users connected to the macro cells.

For small cells (e.g., with a cell radius of a few hundred meters), TDD UL/DL configurations may dynamically change to follow a change of traffic. For example, if the traffic in a small cell shifts toward being more UL-heavy, the TDD UL/DL configuration of the small cell may change to using slots which have more UL symbol periods. The TDD UL/DL configuration of the small cell may be dynamically indicated to user equipments (UEs) in the small cell by, for example, a slot format indicator (SFI) in a downlink control information (DCI). Additionally, or alternatively, the TDD UL/DL configuration of the small cell may be semi-statically configured by a higher layer signaling, such as a radio resource control (RRC) signaling.

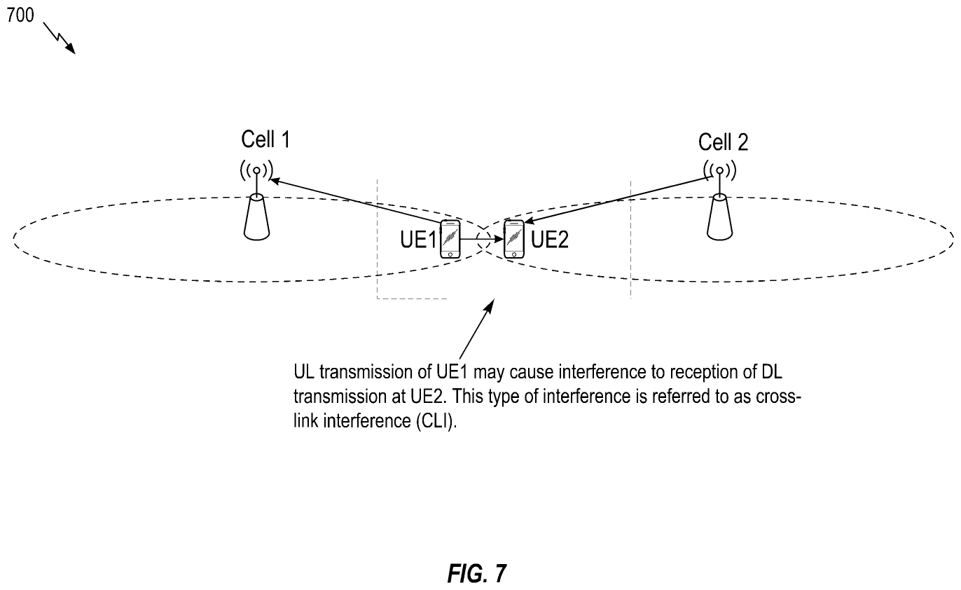

As depicted in a diagram 700 of FIG. 7, multiple neighboring cells (e.g., a first cell (cell 1) and a second cell (cell 2)) may use different TDD UL/DL configurations, and this may lead to conflicting symbol periods. For example, a symbol period of the first cell may be configured for DL, where the same symbol period is configured for UL in the second cell. For example, if a first UE (UE1) associated with the first cell is configured for UL transmission during a symbol period, a second UE (UE2) associated with the second cell is configured to receive DL transmission during the symbol period, and the first UE and the second UE are in close proximity, the UL transmission of the first UE may cause interference to the reception of the DL transmission at the second UE. This type of interference may be referred to a cross-link interference (CLI). In some cases, differing TDD UL/DL configurations at the multiple neighboring cells may result in UE-to-UE CLI when at least one UL symbol of one cell collides with at least one DL symbol of a nearby cell. The CLI may occur near or between cell edge UEs of the nearby cells.

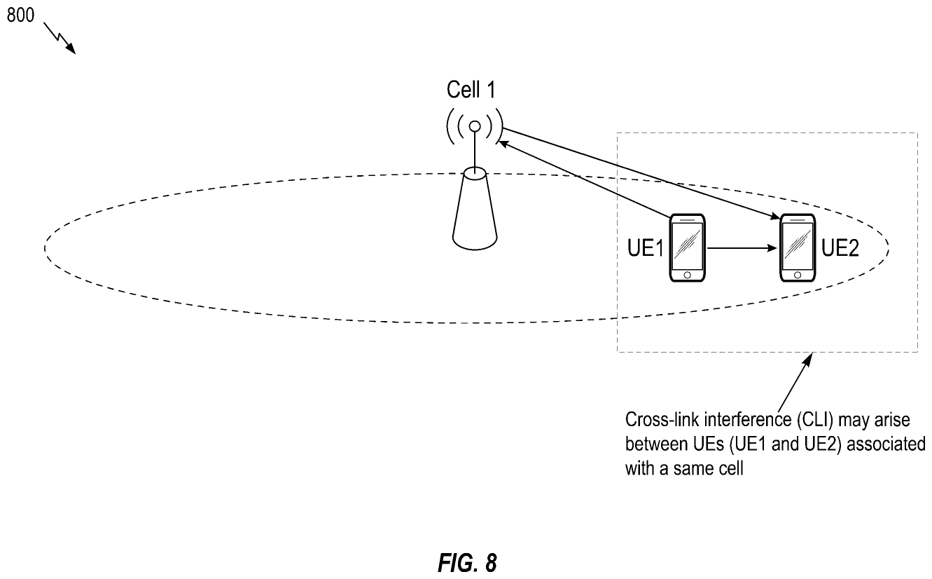

As depicted in a diagram 800 of FIG. 8, the first UE (UE1) and the second UE (UE2) are associated with a same first cell (cell 1). In such cases, the CLI may arise between the first UE and the second UE associated with or within the first cell if a network entity configures different TDD UL DL slot formats to enable better frequency reuse (e.g., for a full-duplex operation). In some cases, the CLI may arise because the network entity may also need to know a level of the CLI to balance DL capacity loss due to inter-UE interference and capacity enhancement by the frequency reuse.

In Rel-16, the CLI is defined to measure interference between the two UEs that are geographically close to each other. For example, when the first UE (i.e., an aggressor UE) is transmitting, the second UE (i.e., a victim UE) located close to the first UE may receive the transmission from the first UE as the CLI if the second UE is receiving transmissions. In some cases, the CLI is defined for a semi-static TDD UL DL slot format difference between the adjacent cells. The slot format is a periodic slot pattern consisting of slots each with DL, UL, flexible symbols, or a mixture of different types of symbols.

In Rel-16, signaling and procedure is specified for the victim UE to measure the CLI from the aggressor UE. In some cases, the aggressor UE does not transmit any transmissions dedicatedly for the CLI measurement by another victim UE. Also, the aggressor UE does not know that the UL transmission from the aggressor UE is being measured for the CLI by the victim UE. The victim UE measures the CLI when the network entity configures CLI measurement resources to the victim UE via an RRC signaling.

In one case, the victim UE performs a periodic measurement to measure the CLI based on a sounding reference signal (SRS) reference signal receive power (RSRP), based on a first set of CLI measurement resources. For example, the CLI may be caused by the SRS transmitted by the aggressor UE to the network entity for the aggressor UE UL channel sounding, and the victim UE may measure the interference caused by the SRS from the aggressor UE UL channel sounding.

In another case, the victim UE performs a periodic measurement to measure the CLI based on a received signal strength indicator (RSSI), based on a second set of CLI measurement resources. For example, the CLI may be caused by any UL transmission (e.g., a physical uplink control channel (PUCCH) transmission, a physical uplink shared channel (PUSCH) transmission, and/or the SRS transmission) from the aggressor UE, and there may be no dedicated transmission from the aggressor UE for the CLI measurement. In some cases, a PUSCH demodulation reference signal (DMRS) from the aggressor UE may be useful for the accurate CLI measurement by the victim UE in a coherent manner.

The victim UE measures the CLI from the aggressor UE based on the SRS RSRP or the RSSI as noted above, and then generates a CLI measurement report indicating the measured CLI. The victim UE sends the CLI measurement report to the network entity. In some cases, based on the CLI measurement report received from the victim UE, the network entity manages scheduling of the aggressor UE and the victim UE to balance a throughput of different UEs.

In Rel-16, only layer 3 (such as an RRC layer) CLI measurement is defined (e.g., due to the semi-static nature of the CLI) to characterize a long-term interference between the nearby UEs around a cell boundary. However, in some cases, a layer 1 (such as a physical (PHY) layer) CLI measurement may support more prompt CLI measurement for a dynamic TDD. The layer 1 CLI measurement may be triggered by a downlink control information (DCI) (e.g., in a similar way to a channel state information (CSI) measurement and report).

The victim UE may dynamically perform the CLI measurement. For example, the dynamic CLI measurement may be triggered, in response to received dynamic signaling such as a physical downlink control channel (PDCCH). In another example, the dynamic CLI measurement may be triggered, in response to received dynamic signaling such as a medium access control (MAC) control element (CE).

The victim UE may promptly capture the CLI due to a dynamic UL scheduling of at least one UL data transmission from the aggressor UE. Also, the dynamic UL scheduling of the at least one UL data transmission may achieve better spectral efficiency than a preconfigured periodic scheduling (i.e., configured grant (CG)) when the network entity operates in a dynamic TDD system.

In some cases, the aggressor UE may not transmit one or more UL transmissions in one or more symbols. For example, there may be no dynamically scheduled UL transmissions (e.g., the PUSCH transmissions, the SRS transmissions) for the aggressor UE in semi-static DL symbols. In another example, there may be no CG scheduled UL transmissions for the aggressor UE in: the semi-static DL symbols, symbols indicated for DL reception scheduled by a dynamic grant, DL symbols indicated by a slot format indicator (SFI) DCI, flexible symbols indicated by the SFI DCI, and/or semi-static flexible symbols. In some cases, the aggressor UE may not receive the SFI DCI indicating a format for a slot containing the symbols, and as a result, the aggressor UE may not transmit the UL transmissions in the symbols.

In some cases, the network entity may not be able to avoid a collision between a dynamically scheduled or CG based UL transmission and at least one symbol (e.g., within which the aggressor UE does not transmit the UL transmissions). For example, when a single DCI may schedule multiple PUSCHs, it is assumed that at least one PUSCH among the multiple PUSCHs may collide with at least one semi-static DL symbol and hence the UE may not transmit said PUSCH. Also, as noted above, although the DCI includes a time domain resource allocation (TDRA) field, however, the TDRA field may not include enough patterns of a start and length indicator vector (SLIV) and a slot offset (K1) to always avoid the collision between the scheduled PUSCH and the semi-static DL symbol.

In some cases, a CG enhancement is provided such that one CG period may contain multiple PUSCH occasions for the multiple PUSCHs. In such cases, the collision between the scheduled PUSCH (e.g., at one of the multiple PUSCH occasions) and the semi-static DL symbol may occur more frequently, since locations of the multiple PUSCH occasions are fixed once the CG is activated. When the collision may happen, the UE may not transmit the scheduled PUSCH. In some cases, a CG-based PUSCH transmission for the UL periodic traffic may be associated with an irregular periodicity. For example, UL video for augmented reality may have a periodicity of 50/3 ms, which may not be aligned with a synchronization signal block (SSB), a search space set, and/or a periodicity of UL-DL slot format pattern.

### Aspects Related to Cross-Link Interference (CLI) Measurement Skipping

As noted above, in a time division duplexing (TDD) network, cross-link interference (CLI) may occur between user equipments (UEs) in a same cell or adjacent cells. For example, uplink (UL) transmissions by a first UE may interfere with downlink (DL) transmissions to a second UE. If the first UE and the second UE may be in different cells that use different TDD UL-DL configurations, it may lead to conflicting symbol periods and UL-DL slot formats (with one UE transmitting on the UL while the other UE is receiving on the DL). In this context, the transmitting UE may be referred to as an aggressor UE, while the receiving UE may be referred to as a victim UE.

In some cases, a victim UE may be configured with a CLI measurement configuration, so that the victim UE may perform (assist in) interference management. For example, a victim UE configured for CLI measurement may measure certain (time/frequency) resources at times when another UE/aggressor UE may be transmitting reference signals (RSs), such as sounding reference signals (SRSs). The CLI measurements may include measurements of the SRSs.

For various reasons, the aggressor UE may not transmit the RS used for the CLI at one or more semi-static DL symbols. For example, there may be no scheduling of the one or more RSs at the one or more semi-static DL symbols. In another example, the aggressor UE may not receive an indication of a format for a slot containing the one or more semi-static DL symbols and, thus, may be unable to transmit the one or more RSs at the one or more semi-static DL symbols.

Unfortunately, if CLI RS is not transmitted in a CLI measurement occasion per the CLI measurement configuration, CLI measurement accuracy may suffer and may result in unnecessary power consumption at the victim UE. Aspects of the present disclosure, however, allow the victim UE to skip CLI measurement occasions if the victim UE determines the aggressor UE will not transmit CLI RS. For example, the victim UE may skip the CLI measurement occasions that overlap with the one or more semi-static DL symbols (in which the aggressor UE will not transmit).

Particular aspects of the subject matter described in this disclosure can be implemented to realize one or more of the following potential advantages. In some examples, the described techniques can be used to improve CLI measurement accuracy and reduce a power consumption of the victim UE by skipping CLI measurement occasions when the CLI RS transmission is not expected.

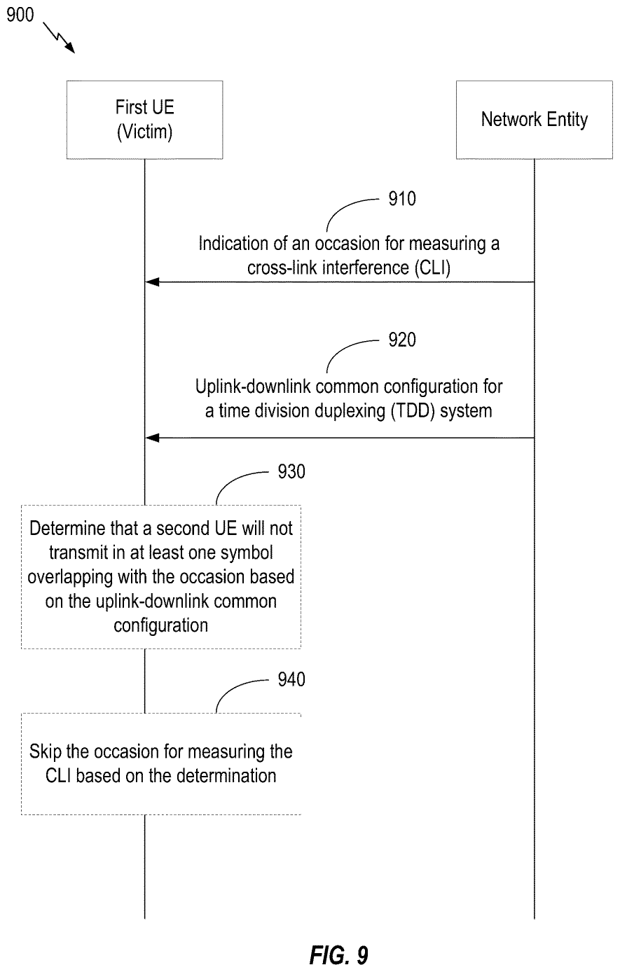

The techniques proposed herein for CLI measurement occasion skipping may be understood with reference to FIGS. 9-15.

FIG. 9 depicts a call flow diagram 900 illustrating an example of CLI measurement occasion by a first UE (e.g., the victim UE). The UE shown in FIG. 9 may be an example of the UE 104 depicted and described with respect to FIGS. 1 and 3. The network entity depicted in FIG. 9 may be an example of the BS 102 depicted and described with respect to FIGS. 1 and 3, or the disaggregated BS depicted and described with respect to FIG. 2.

As indicated at 910, the network entity may transmit an indication of an occasion for measuring a CLI to the first UE. In certain aspects, the network entity may transmit the indication of multiple occasions for measuring the CLI to the first UE.

As indicated at 920, the network entity may transmit an uplink (UL)-downlink (DL) common configuration for a time division duplexing (TDD) system (e.g., tdd-UL-DL-ConfigurationCommon). In one example, the network entity may transmit the UL-DL common configuration and the indication of the occasion to the first UE at a same time. In another example, the network entity may transmit the UL-DL common configuration and the indication of the occasion to the first UE at different times.

In certain aspects, the UL-DL common configuration indicates one or more symbols. In one example, the one or more symbols may be DL symbols. In another example, the one or more symbols may be flexible symbols. In another example, the one or more symbols may be the DL symbols and the flexible symbols.

As indicated at 930, the first UE determines that a second UE (e.g., the aggressor UE, such as the UE 104 depicted and described with respect to FIGS. 1 and 3) will not transmit in at least one symbol (e.g., of the one or more symbols) overlapping with the occasion, based on information associated with the UL-DL common configuration. In one example, the first UE may determine that at least one DL symbol may overlap with the occasion, and the second UE may not transmit in the at least one DL symbol. In another example, the first UE may determine that at least one flexible symbol may overlap with the occasion, and the second UE may not transmit in the at least one flexible symbol.

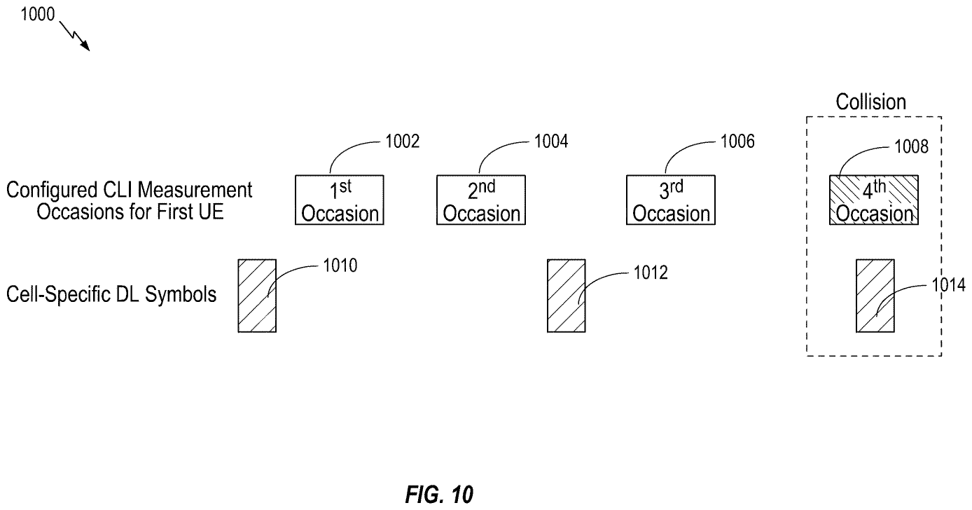

Diagram 1000 of FIG. 10 depicts an example configuration of multiple occasions (e.g., configured for the first UE for measuring the CLI) and DL symbols (e.g., cell-specific DL symbols). The multiple occasions include a first occasion 1002, a second occasion 1004, a third occasion 1006, and a fourth occasion 1008. The multiple DL symbols include a first DL symbol 1010, a second DL symbol 1012, and a third DL symbol 1014. As depicted in FIG. 10, at least one occasion is in conflict with at least one DL symbol. For example, the fourth occasion 1008 overlaps with (or collides with) the third DL symbol 1014. Also, the second UE may not transmit one or more UL transmissions in the at least one DL symbol such as the third DL symbol 1014.

Referring back to FIG. 9, in certain aspects, the first UE may receive a configuration (e.g., ssb-PositionsInBurst) indicating one or more synchronization signal block (SSB) symbols for one or more SSBs. In such cases, the at least one flexible symbol may be within the one or more SSB symbols for the one or more SSBs.

In certain aspects, the first UE may receive a physical downlink control channel (PDCCH) system information block1 (SIB1) configuration (e.g., pdcch-ConfigSIB1) in a master information block (MIB). This configuration indicates one or more symbols for a control resource set (CORESET) for a set (e.g., Type0-PDCCH common search space set (i.e., search space set #0)). In such cases, the at least one flexible symbol may be within the one or more symbols for the CORESET.

As indicated at 940, the first UE skips the occasion for measuring the CLI, in response to the determination that the second UE will not transmit in the at least one symbol overlapping with the occasion.

In certain aspects, the first UE may receive dynamic signaling triggering the CLI measurement. In certain aspects, the first UE may receive radio resource control (RRC) signaling periodically scheduling the CLI measurement. In certain aspects, the first UE may receive the RRC signaling semi-persistently scheduling the CLI measurement.

In certain aspects, since both a dynamically scheduled UL transmission and a configured grant (CG)-based UL transmission from the second UE may collide with the at least one symbol (e.g., a semi-static DL symbol), a corresponding occasion (e.g., CLI measurement occasion) for measuring the CLI (e.g., triggered by dynamic signaling or configured by RRC signaling) may collide with the semi-static DL symbol.

In certain aspects, the first UE may receive a measurement configuration for the CLI measurement. The measurement configuration indicates one or more filter coefficients for different CLI measurement quantities and/or different signal types.

The first UE may adapt one or more values of the one or more filter coefficients (e.g., in response to skipping the occasion for measuring the CLI). For example, when the CLI measurement on each occasion for measuring the CLI is filtered and the first UE skips the occasion, the first UE may adapt the one or more filter coefficients to preserve constant filtering and time characteristics of one or more filters corresponding to the one or more filter coefficients.

The first UE may determine a number of occasions configured for measuring the CLI that have been skipped by the first UE. The first UE may adapt the one or more values of the one or more filter coefficients, in accordance with the determined number of occasions. For example, the one or more values of the one or more filter coefficients may increase after each skipped occasion for measuring the CLI. In some cases, the higher the number of occasions skipped by the first UE, the larger the increase in the one or more values of the one or more filter coefficients.

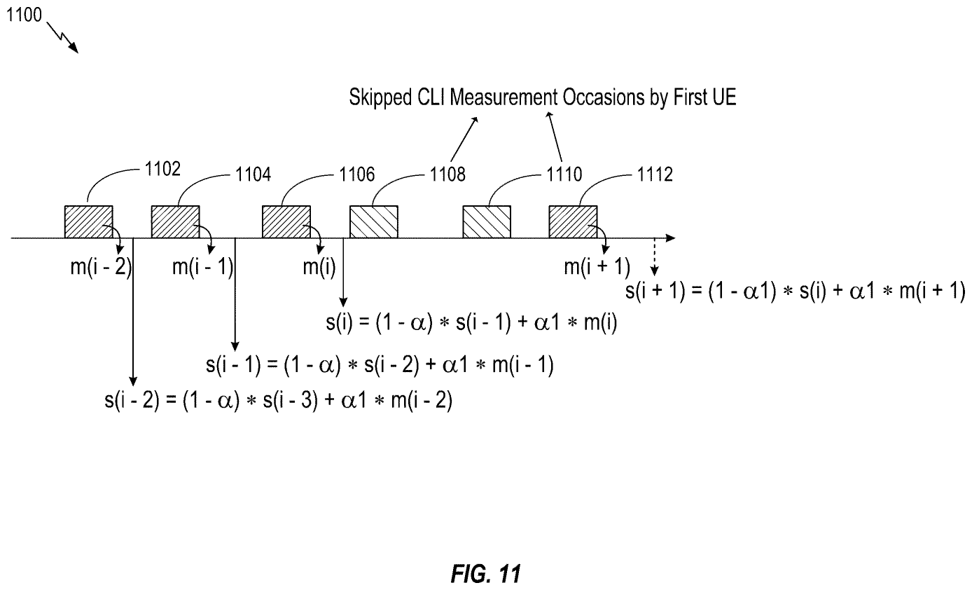

FIG. 11 depicts a diagram 1100 of multiple occasions configured for the first UE. The multiple occasions include a first occasion 1102, a second occasion 1104, a third occasion 1106, a fourth occasion 1108, a fifth occasion 1110, and a sixth occasion 1112. The first UE may measure the CLI at some of the multiple occasions such as the first occasion 1102, the second occasion 1104, the third occasion 1106, and the sixth occasion 1112. The first UE may skip measuring the CLI at some of the multiple occasions such as the fourth occasion 1108 and the fifth occasion 1110.

At the third occasion 1106, m(i) represents the CLI measurement for index i and s(i) is a filtered value (state). The s(i) is based at least on a filter coefficient (α). A value of α is 0.01. In some cases (e.g., for a one-tap infinite impulse response (IIR) filter), the s(i) may continually track the CLI measurement variation.

When the first UE skips measuring the CLI at one or more occasions (e.g., at the fourth occasion 1108, the fifth occasion 1110), the missed CLI measurement may lose an impact of s(t).

In certain aspects, to accurately and quickly track the real CLI measurement variation (e.g., when the first UE skips measuring the CLI at the fourth occasion 1108 and the fifth occasion 1110), for a new CLI measurement (e.g., at the sixth occasion 1112), a new filter coefficient α1 is set (e.g., whose value is larger than the α). The larger value of the α1 may be based on (e.g., proportional or exponential) to a number of skipped occasions. For example, when the first UE skips two occasions such as the fourth occasion 1108 and the fifth occasion 1110, the value of the α1 can be α1=(2+1)*α. That is, the value of α1 is 0.03. In some cases, the value of the x1 can be α1=1 (1−α)²⁺¹. That is, the value of a 1 is 0.0297.

Referring back to FIG. 9, the first UE and the second UE may be associated with a same serving cell. In such cases, the CLI measurement corresponds to an intra-cell CLI measurement.

In certain aspects, the first UE and the second UE may be associated with different serving cells. For example, the first UE and the second UE may be cell edge UEs for macro cells. In such cases, the CLI measurement corresponds to an inter-cell CLI measurement.

In certain aspects, the first UE may check for a collision between the occasion and the at least one symbol configured for a serving cell of the second UE.

In certain aspects, the first UE may receive (e.g., after skipping the CLI measurement) one or more downlink transmissions on the at least one symbol overlapping with the occasion. In such cases, the at least one symbol may be at least one DL symbol. The one or more downlink transmissions may be to estimate a quality of a channel between the first UE and a network entity (e.g., for tracking channel quality indicator (CQI) on one or more orthogonal frequency division multiplexing (OFDM) symbols overlapping with one or more configured CLI measurement resources). In one example, the one or more downlink transmissions may be one or more CSI-reference signals (RSS). In another example, the one or more downlink transmissions may be one or more PDCCH transmissions. In another example, the one or more downlink transmissions may be one or more physical downlink shared channel (PDSCH) transmissions.

In certain aspects, to reduce UL latency and increase the energy for UL transmissions, a sub-band full duplex (SBFD) mode is proposed in which some slots are SBFD slots modified to support frequency duplexing for simultaneous UL and DL transmissions. Some other slots may remain as legacy time division duplex (TDD) slots such that one slot is still dedicated to DL and another slot dedicated to UL.

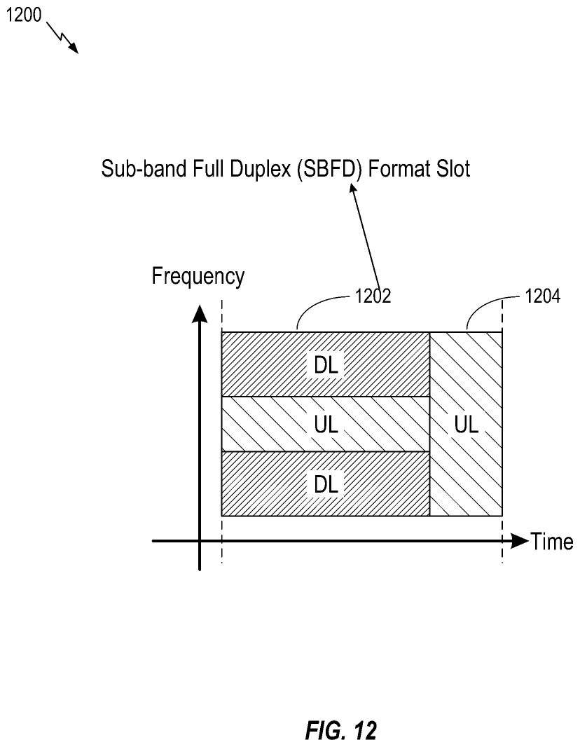

An example slot format for legacy TDD and SBFD communication is depicted in a diagram 1200 of FIG. 12. As depicted in FIG. 12, a first slot 1202 is a SBFD slot dedicated to DL and UL transmissions, and a second slot 1204 is a legacy TDD slot that is dedicated to UL transmissions. The second slot may thus be designated as a UL TDD slot.

In certain aspects, neither the UL nor the DL in the first slot 1202 may occupy the entire frequency resource range (e.g., a frequency band) for the first slot 1202. Instead, the UL occupies a central sub-band in the frequency band for the first slot 1202. The DL occupies a lower sub-band that ranges from the lower frequency for frequency band up to a lowest frequency for the UL central sub-band. In certain aspects, the sub-bands may be separated by a guard band. The DL also occupies an upper sub-band in the frequency band and extends from a greatest frequency for the UL central sub-band to a greatest frequency for the frequency band.

In certain aspects, the UL central sub-band may be symmetric about a center frequency for the first slot 1202. In such cases, the bandwidth for the DL lower sub-band and the DL upper sub-band may be equal. However, in some cases, the DL lower sub-band bandwidth may be different from the bandwidth for the DL upper sub-band.

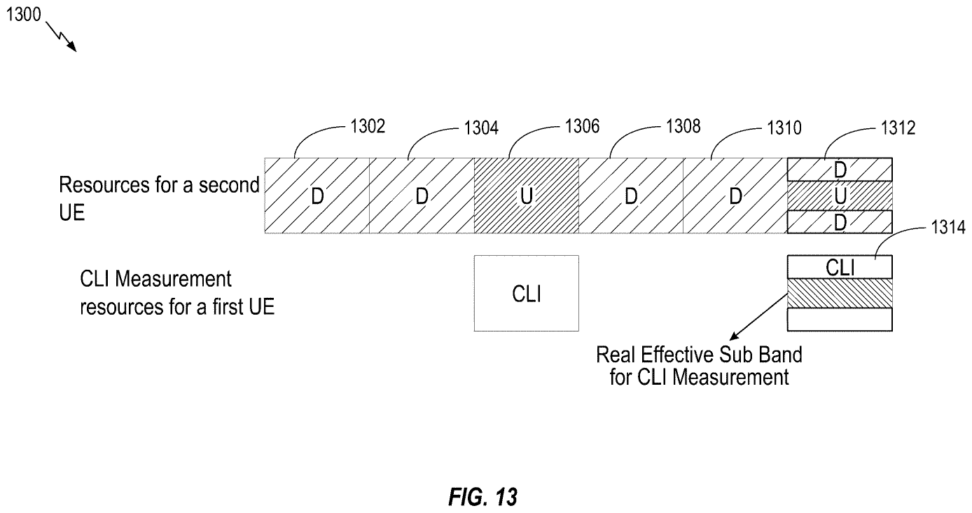

FIG. 13 depicts a diagram 1300 showing resources for a first UE and resources for a second UE. The resources for the second UE include a first DL resource 1302 for a DL transmission, a second DL resource 1304 for the DL transmission, a first UL resource 1306 for a UL transmission, a third DL resource 1308 for the DL transmission, a fourth DL resource 1310 for the DL transmission, and a first SBFD resource 1312 for the DL and UL transmissions.

In certain aspects, the cell-specific DL signals may not be configured with the SBFD, so there may be no conflict between a first CLI resource 1314 (e.g., CLI measurement occasion) for the first UE and the first SBFD resource 1312. In certain aspects, even when there is the conflict between the first CLI resource 1314 and the first SBFD resource 1312, the first UE may not need to skip the first CLI resource 1314. This is because the second UE may still be able to transmit the UL transmission in a UL sub-band of the first SBFD resource 1312, and the first UE may still be able to measure the CLI (although the measured CLI may not be accurate). Accordingly, in such cases, the first UE may maintain the first CLI resource 1314 and continue with the CLI measurement, skip the CLI measurement associated with the SBFD, and/or continue with the CLI measurement at the first CLI resource 1314 and post-adjust the measured CLI.

### Example Method for Wireless Communications by a First User Equipment (UE)

FIG. 14 shows an example of a method 1400 for wireless communications by a first user equipment (UE), such as the UE 104 of FIGS. 1 and 3.

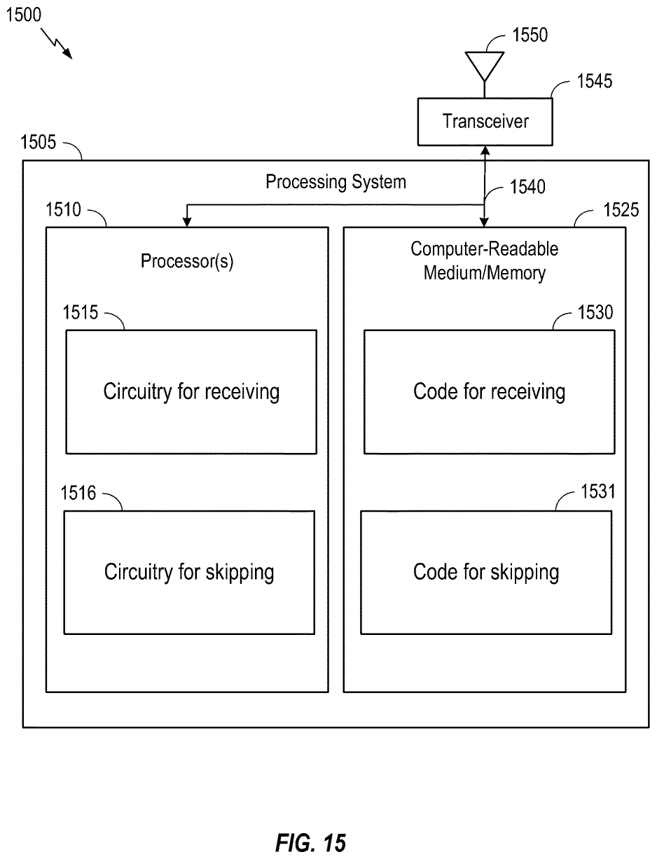

Method 1400 begins at step 1410 with receiving an indication that a second UE will not transmit in at least one symbol overlapping with an occasion configured for the first UE for measuring a cross-link interference (CLI). In some cases, the operations of this step refer to, or may be performed by, circuitry for receiving and/or code for receiving as described with reference to FIG. 15.

Method 1400 then proceeds to step 1420 with skipping the occasion for measuring the CLI, in response to the received indication. In some cases, the operations of this step refer to, or may be performed by, circuitry for skipping and/or code for skipping as described with reference to FIG. 15.

In certain aspects, the indication indicates an uplink (UL)-downlink (DL) common configuration for a time division duplexing (TDD) system; the UL-DL common configuration indicates the at least one symbol; and the symbol is at least one of: a downlink symbol or a flexible symbol.

In certain aspects, the method 1400 further includes receiving a configuration indicating one or more synchronization signal block (SSB) symbols for one or more SSBs where the flexible symbol is one of the one or more SSB symbols.

In certain aspects, the method 1400 further includes receiving a physical downlink control channel (PDCCH) system information block1 (SIB1) configuration indicating one or more symbols for a control resource set (CORESET) where the flexible symbol is one of the one or more symbols.

In certain aspects, the method 1400 further includes receiving dynamic signaling triggering the CLI measurement.

In certain aspects, the method 1400 further includes receiving radio resource control (RRC) signaling periodically or semi-persistently scheduling the CLI measurement.

In certain aspects, the method 1400 further includes receiving a measurement configuration for the CLI measurement where the measurement configuration indicates one or more filter coefficients for at least one of: different CLI measurement quantities or different signal types.

In certain aspects, the method 1400 further includes adapting one or more values of the one or more filter coefficients, in response to skipping the occasion for measuring the CLI.

In certain aspects, the method 1400 further includes determining a number of occasions configured for measuring the CLI that have been skipped by the first UE, and the adapting further includes adapting the one or more values of the one or more filter coefficients, in accordance with the determined number of occasions.

In certain aspects, the first UE and the second UE are associated with a same serving cell, and the CLI measurement corresponds to an intra-cell CLI measurement.

In certain aspects, the first UE and the second UE are associated with different serving cells, and the CLI measurement corresponds to an inter-cell CLI measurement.

In certain aspects, the method 1400 further includes receiving, after skipping the CLI measurement, one or more downlink transmissions on one or more downlink symbols overlapping with the occasion.

In certain aspects, the one or more downlink transmissions include a channel state information (CSI) reference signal (RS) to estimate a quality of a channel between the first UE and a network entity.

In one aspect, the method 1400, or any aspect related to it, may be performed by an apparatus, such as a communications device 1500 of FIG. 15, which includes various components operable, configured, or adapted to perform the method 1400. The communications device 1500 is described below in further detail.

Note that FIG. 14 is just one example of a method, and other methods including fewer, additional, or alternative steps are possible consistent with this disclosure.

### Example Communications Device

FIG. 15 depicts aspects of an example communications device 1500. In some aspects, communications device 1500 is a first user equipment (UE), such as UE 104 described above with respect to FIGS. 1 and 3.

The communications device 1500 includes a processing system 1505 coupled to a transceiver 1545 (e.g., a transmitter and/or a receiver). The transceiver 1545 is configured to transmit and receive signals for the communications device 1500 via an antenna 1550, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1525 via a bus 1540. In certain aspects, the computer-readable medium/memory 1525 is configured to store instructions (e.g., computer-executable code) that when executed by the one or more processors 1510, cause the one or more processors 1510 to perform the method 1400 described with respect to FIG. 14. Note that reference to a processor performing a function of communications device 1500 may include one or more processors 1510 performing that function of communications device 1500.

In the depicted example, computer-readable medium/memory 1525 stores code (e.g., executable instructions), such as code for receiving 1530 and code for skipping 1531. Processing of the code for receiving 1530 and the code for skipping 1531 may cause the communications device 1500 to perform the method 1400 described with respect to FIG. 14.

The one or more processors 1510 include circuitry configured to implement (e.g., execute) the code stored in the computer-readable medium/memory 1525, including circuitry such as circuitry for receiving 1515 and circuitry for skipping 1516. Processing with the circuitry for receiving 1515 and the circuitry for skipping 1516 may cause the communications device 1500 to perform the method 1400 described with respect to FIG. 14.

Various components of the communications device 1500 may provide means for performing the method 1400 described with respect to FIG. 14. For example, means for receiving or obtaining may include transceivers 354 and/or antenna(s) 352 of the UE 104 illustrated in FIG. 3 and/or the circuitry for receiving 1515, the code for receiving 1530, the transceiver 1545 and the antenna 1550 of the communications device 1500 in FIG. 15.

In some cases, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 15 is an example, and many other examples and configurations of communication device 1500 are possible.

### EXAMPLE CLAUSES

Implementation examples are described in the following numbered clauses:

Clause 1: A method for wireless communications at a first user equipment (UE), comprising: receiving an indication that a second UE will not transmit in at least one symbol overlapping with an occasion configured for the first UE for measuring a cross-link interference (CLI); and skipping the occasion for measuring the CLI, in response to the received indication.

Clause 2: The method of clause 1, wherein: the indication indicates an uplink-downlink common configuration for a time division duplexing (TDD) system; the uplink-downlink common configuration indicates the at least one symbol; and the symbol is at least one of: a downlink symbol or a flexible symbol.

Clause 3: The method of clause 2, further comprising receiving a configuration indicating one or more synchronization signal block (SSB) symbols for one or more SSBs, wherein the flexible symbol is one of the one or more SSB symbols.

Clause 4: The method of clause 2, further comprising receiving a physical downlink control channel (PDCCH) system information block1 (SIB1) configuration indicating one or more symbols for a control resource set (CORESET), wherein the flexible symbol is one of the one or more symbols.

Clause 5: The method of any one of clauses 1-4, further comprising receiving dynamic signaling triggering the CLI measurement.

Clause 6: The method of any one of clauses 1-5, further comprising receiving radio resource control (RRC) signaling periodically or semi-persistently scheduling the CLI measurement.

Clause 7: The method of any one of clauses 1-6, further comprising receiving a measurement configuration for the CLI measurement, wherein the measurement configuration indicates one or more filter coefficients for at least one of: different CLI measurement quantities or different signal types.

Clause 8: The method of clause 7, further comprising adapting one or more values of the one or more filter coefficients, in response to skipping the occasion for measuring the CLI.

Clause 9: The method of clause 8, further comprising: determining a number of occasions configured for measuring the CLI that have been skipped by the first UE, and the adapting further comprises adapting the one or more values of the one or more filter coefficients, in accordance with the determined number of occasions.

Clause 10: The method of any one of clauses 1-9, wherein: the first UE and the second UE are associated with a same serving cell, and the CLI measurement corresponds to an intra-cell CLI measurement.

Clause 11: The method of any one of clauses 1-10, wherein: the first UE and the second UE are associated with different serving cells, and the CLI measurement corresponds to an inter-cell CLI measurement.

Clause 12: The method of any one of clauses 1-11, further comprising receiving, after skipping the CLI measurement, one or more downlink transmissions on one or more downlink symbols overlapping with the occasion.

Clause 13: The method of clause 12, wherein the one or more downlink transmissions comprise a channel state information (CSI) reference signal (RS) to estimate a quality of a channel between the first UE and a network entity.

Clause 14: An apparatus, comprising: a memory comprising executable instructions; and a processor configured to execute the executable instructions and cause the apparatus to perform a method in accordance with any one of Clauses 1-13.

Clause 15: An apparatus, comprising means for performing a method in accordance with any one of Clauses 1-13.

Clause 16: A non-transitory computer-readable medium comprising executable instructions that, when executed by a processor of an apparatus, cause the apparatus to perform a method in accordance with any one of Clauses 1-13.

Clause 17: A computer program product embodied on a computer-readable storage medium comprising code for performing a method in accordance with any one of Clauses 1-13.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communications at a first user equipment (UE), comprising:
a processor;
a memory coupled with the processor; and
instructions stored in the memory and executable by the processor to cause the apparatus to:
receive an indication that a second UE will not transmit in at least one symbol overlapping with an occasion configured for the first UE for measuring a cross-link interference (CLI); and
skip the occasion for measuring the CLI, in response to the received indication.

2. The apparatus of claim 1, wherein:
the indication indicates an uplink-downlink common configuration for a time division duplexing (TDD) system;
the uplink-downlink common configuration indicates the at least one symbol; and
the symbol is at least one of: a downlink symbol or a flexible symbol.

3. The apparatus of claim 2, wherein the instructions stored in the memory and executable by the processor further cause the apparatus to: receive a configuration indicating one or more synchronization signal block (SSB) symbols for one or more SSBs, wherein the flexible symbol is one of the one or more SSB symbols.

4. The apparatus of claim 2, wherein the instructions stored in the memory and executable by the processor further cause the apparatus to: receive a physical downlink control channel (PDCCH) system information block1 (SIB1) configuration indicating one or more symbols for a control resource set (CORESET), wherein the flexible symbol is one of the one or more symbols.

5. The apparatus of claim 1, wherein the instructions stored in the memory and executable by the processor further cause the apparatus to: receive dynamic signaling triggering the CLI measurement.

6. The apparatus of claim 1, wherein the instructions stored in the memory and executable by the processor further cause the apparatus to: receive radio resource control (RRC) signaling periodically or semi-persistently scheduling the CLI measurement.

7. The apparatus of claim 1, wherein the instructions stored in the memory and executable by the processor further cause the apparatus to: receive a measurement configuration for the CLI measurement, wherein the measurement configuration indicates one or more filter coefficients for at least one of: different CLI measurement quantities or different signal types.

8. The apparatus of claim 7, wherein the instructions stored in the memory and executable by the processor further cause the apparatus to: adapt one or more values of the one or more filter coefficients, in response to skipping the occasion for measuring the CLI.

9. The apparatus of claim 8, wherein the instructions stored in the memory and executable by the processor further cause the apparatus to:
determine a number of occasions configured for measuring the CLI that have been skipped by the first UE, and
adapt the one or more values of the one or more filter coefficients, in accordance with the determined number of occasions.

10. The apparatus of claim 1, wherein:
the first UE and the second UE are associated with a same serving cell, and
the CLI measurement corresponds to an intra-cell CLI measurement.

11. The apparatus of claim 1, wherein:
the first UE and the second UE are associated with different serving cells, and
the CLI measurement corresponds to an inter-cell CLI measurement.

12. The apparatus of claim 1, wherein the instructions stored in the memory and executable by the processor further cause the apparatus to: receive, after skipping the CLI measurement, one or more downlink transmissions on one or more downlink symbols overlapping with the occasion.

13. The apparatus of claim 12, wherein the one or more downlink transmissions comprise a channel state information (CSI) reference signal (RS) to estimate a quality of a channel between the first UE and a network entity.

14. A method for wireless communications at a first user equipment (UE), comprising:
receiving an indication that a second UE will not transmit in at least one symbol overlapping with an occasion configured for the first UE for measuring a cross-link interference (CLI); and
skipping the occasion for measuring the CLI, in response to the received indication.

15. The method of claim 14, wherein:
the indication indicates an uplink-downlink common configuration for a time division duplexing (TDD) system;
the uplink-downlink common configuration indicates the at least one symbol; and
the symbol is at least one of: a downlink symbol or a flexible symbol.

16. The method of claim 15, further comprising receiving a configuration indicating one or more synchronization signal block (SSB) symbols for one or more SSBs, wherein the flexible symbol is one of the one or more SSB symbols.

17. The method of claim 15, further comprising receiving a physical downlink control channel (PDCCH) system information block1 (SIB1) configuration indicating one or more symbols for a control resource set (CORESET), wherein the flexible symbol is one of the one or more symbols.

18. The method of claim 14, further comprising receiving dynamic signaling triggering the CLI measurement.

19. A non-transitory computer-readable medium comprising computer-executable instructions that, when executed by a processor of a first user equipment (UE), cause the first UE to perform a method of wireless communications, comprising:
receiving an indication that a second UE will not transmit in at least one symbol overlapping with an occasion configured for the first UE for measuring a cross-link interference (CLI); and
skipping the occasion for measuring the CLI, in response to the received indication.

20. The non-transitory computer-readable medium of claim 19, wherein:
the indication indicates an uplink-downlink common configuration for a time division duplexing (TDD) system;
the uplink-downlink common configuration indicates the at least one symbol; and
the symbol is at least one of: a downlink symbol or a flexible symbol.
